(19) United States
(12) Patent Application Publication
(10) Pub. No.: US 2026/0340160 A1
(43) Pub. Date: Oct. 29, 2026

(54) ZERO TRUST EVENT BUS STREAM

(71) Applicant: Oracle International Corporation, Redwood Shores, CA (US)

(72) Inventors: Robert Van Gorkom, Olympia, WA (US); Andrei Vorobiev, Henderson, NV (US); Joel Rowles, Briar, WA (US); Alessandro Muti, Mercer Island, WA (US)

(73) Assignee: Oracle International Corporation, Redwood Shores, CA (US)

(21) Appl. No.: 19/427,806

(22) Filed: Dec. 19, 2025

Related U.S. Application Data
(60) Provisional application No. 63/793,579, filed on Apr. 23, 2025.

(51) Int. Cl. G06F 21/60

(52) U.S. Cl. CPC G06F 21/606

(57) ABSTRACT

The present disclosure relate to techniques enabling secure communication exchange between independent systems by leveraging a zero-trust event bus stream. To enable secure communication exchange, a control plane may onboard a consumer organization by processing a first pull request associated with a producer organization and a second pull request associated with the consumer organization. A Java client may be automatically generated based on a combined contract definition associated with the first pull request and the second pull request. Based on the Java client generated, an artifactory may build artifacts of the Java client to deploy it to both the producer organization and the consumer organization. The producer organization and the consumer organization may utilize the deployed Java client to exchange their communication via the zero-trust event bus stream.

### CROSS-REFERENCE TO RELATED APPLICATIONS

This application claims the benefit of and the priority to U.S. Provisional Application Number 63/793,579, filed on Apr. 23, 2025, which is hereby incorporated by reference in its entirety for all purposes.

### BACKGROUND

Enterprises in sectors such as healthcare, finance, and logistics often rely on distributed systems that are independently managed across departments or organizations. While these systems support specialized operations within sectors, typically functioning in isolation, making secure and interoperable communication between the distributed systems increasingly difficult. In healthcare industry, for example, independent platforms handling patient registration, billing, diagnostics, pharmacy, insurance processing, and electronic health records (EHRs) may often operate using disparate communication protocols and data formats, resulting in significant barriers to seamless and secure information exchange.

Traditional communication methods may rely on complex, fragmented, and manually configured connections, which may increase operational overhead and introduce security vulnerabilities. These traditional communication methods may not be difficult to scale but also susceptible to data breaches and access inconsistencies, particularly when handling sensitive information (e.g., confidential nature of healthcare data streams). Furthermore, many organizations or departments within enterprises may rely on isolated, on-premises systems, lacking a unified platform, making seamless data exchange across independent systems challenging, thereby impacting scalability, efficiency, and compliance.

### SUMMARY

Certain aspects of the present disclosure relate to techniques enabling secure communication exchange between independent systems by leveraging a zero-trust event bus stream. The zero-trust event bus stream, referred to herein as a streaming service, may function as a unified platform deployed on a cloud infrastructure, offering a bidirectional messaging interface that may enable the independent systems including a producer organization and a consumer organization to exchange encrypted data streams over a configurable duration (e.g., messages delivered at one-minute intervals). The secure communication between these organizations may be based on a combined contract definition, which may be formed by merging pull requests generated by the producer organization and the consumer organization. It will be appreciated that when the disclosure herein refers to a “pull request”, any onboarding request or definition submission request may further or alternatively be used.

In some aspects, the producer organization may generate a first pull request comprising definitions specific to the producer organization while the consumer organization may generate a second pull request comprising definitions specific to the consumer organization. Each pull request may also be associated with a metadata. For instance, the metadata associated with the first pull request may include configuration files, object definitions, and unit tests while the metadata associated with the second pull request may include attributes such as entity identifier, domain affiliation, and access intent. To streamline both the producer and the consumer organization, the generated first pull request and the second pull request may be merged by interpreting the definitions to validate and authorize the consumer organization, enabling it to receive data streams delivered by the producer organization.

To perform this validation, a series of operations may be executed to evaluate the metadata associated with the second pull request against the metadata from the first pull request. This may include cross-referencing the metadata associated with the second pull request such as entity identifiers, domain affiliations, and access intents against configuration parameters and object definitions associated with the producer organization. Upon successful validation, the consumer organization may be authorized according to a set of predefined policies, which may include role-based access control, domain-level trust boundaries, and stream-specific encryption requirements. These policies may collectively govern how consumer organizations may interact with producer organizations and may ensure that organizations with verified domain affiliations and legitimate access intents may be permitted to receive encrypted event messages.

Once merged, the combined contract definition may be generated, which may refer to a unified set of rules that may reflect a mutual agreement derived from the pull requests, including the first and second pull requests generated by the producer and consumer organizations. These definitions, for example, entity identifiers, configuration files, or object definitions, may form a shared agreement that may standardize how both organizations may exchange data streams through the streaming service, thereby facilitating compatibility, security, and interoperability. This approach may also facilitate secure, compliant, and context-aware communication exchange between the producer and consumer organizations.

Based on the combined contract definition, some of the disclosed techniques may generate a Java client may refer to a deployable software artifact associated with the producer and consumer organizations. This association may be based on a distribution process that may distribute the Java client to both organizations using an artifactory—a repository manager designed to store, manage, and deliver software components such as build artifacts, libraries, and executables. This distribution process may enable each organization to receive correct and consistent version of the Java client. Once deployed, the Java client may encapsulate and abstract the complexity of disparate application programmable interfaces (APIs), protocols, and connection mechanisms, thereby simplifying cross-system communication, reducing operational overhead, and facilitating scalability and reliability across independent systems. Furthermore, the combined contract definition may be stored within a centralized contract repository, which may be implemented using any suitable storage solution capable of submitting, reviewing, approving, retrieving, and managing access to contract definitions. The repository need not be a version-control system; it may be a generic file repository, an object store, a configuration registry, or an API-driven storage service, optionally including versioning capabilities.

Some of the disclosed techniques may further leverage a shepherd deployment process to deploy the streaming service across the producer and consumer organizations. The shepherd deployment process may refer to a coordinated deployment strategy that may enable services to be provisioned in a consistent, monitored, and staged manner. By leveraging the shepherd deployment process, the streaming service may reduce downtime, mitigate deployment-related errors, and maintain operational continuity. The streaming service may be deployed using the cloud infrastructure, which may provide required hosting resources to run and scale the services reliably.

After deployment, the Java client may facilitate secure communication exchange across producer and consumer organizations. In some aspects, the Java client may manage encryption and decryption operations associated with the cross-system communication. To manage encryption and decryption operations, the Java client may be configured to generate cryptographic key pairs for both the producer and consumer organizations to secure data exchange. These generated key pairs may be dynamically updated in response to specific conditions, such as key expiration, changes in configuration parameters, or revocation events. This dynamic key management may enable both organizations to securely encrypt and decrypt their respective data streams, thereby supporting robust security mechanisms for communication exchange.

In some aspects, a system is provided that includes one or more data processors and a non-transitory computer readable storage medium containing instruction which, when executed on the one or more data processors, cause the one or more data processors to perform part or all of one or more methods disclosed herein.

In some aspects, a computer-program product tangibly embodied in a non-transitory machine-readable storage medium, including instructions configured to cause one or more data processors to perform part or all of one or more methods or processes disclosed herein.

In some aspects, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure claimed. Thus, it should be understood that although the present invention as claimed has been specifically disclosed by aspects and optional features, modification and variation of the concepts herein disclosed may be resorted to by those skilled in the art, and that such modifications and variations are considered to be within the scope of this disclosure as defined by the appended claims.

### BRIEF DESCRIPTION OF THE DRAWINGS

Various aspects are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates an exemplary cross-communication architecture configured to facilitate secure data exchange between a producer organization and a consumer organization via a streaming service, in accordance with some aspects of the present disclosure.

FIG. 2 illustrates a block diagram depicting a streamlining of the producer organization and the consumer organization for secure data exchange via the streaming service, in accordance with some aspects of the present disclosure.

FIG. 3 illustrates a block diagram depicting the onboarding of the consumer organization by leveraging a control plane, in accordance with at least one aspect of the present disclosure.

FIG. 4 presents an exemplary block diagram, illustrating deployment of a Java client to facilitate secure communication exchange via the streaming service, in accordance with some aspects of the present disclosure.

FIG. 5 illustrates a sequence diagram of secure data exchange between the producer organization and the consumer organization via the streaming service, in accordance with some aspects of the present disclosure.

FIG. 6 illustrates a workflow for enabling secure communication between the producer organization and the consumer organization, in accordance with some aspects of the present disclosure.

FIG. 7 depicts a simplified diagram of a distributed system for implementing an aspect of the present disclosure.

FIG. 8 is a simplified block diagram of a cloud system environment in accordance with certain aspects of various embodiments of the disclosure.

FIG. 9 illustrates an exemplary computer system that may be used to implement certain aspects of the present disclosure.

### DETAILED DESCRIPTION

Some aspects of the present disclosure relate to techniques for enabling secure communication exchange between independent systems by leveraging a zero-trust event bus stream. The zero-trust event bus stream may be leveraged based on validation and authorization of a producer organization and a consumer organization by interpreting pull requests (e.g., a first pull request and a second pull request). The first pull request may be generated by the producer organization comprising definitions while the second pull request may be generated by the consumer organization comprising definitions. These definitions may comprise access intent, domain affiliation, entity identifiers, and/or expected data formats. Based on the pull requests, the zero-trust event bus stream—hereinafter referred to as a streaming service—may autonomously activate a processing pipeline to establish a secure and reliable communication channel. The streaming service may operate as a unified platform deployed on a cloud infrastructure, offering a bidirectional messaging interface that may enable the producer organization and the consumer organization to exchange encrypted data streams over a configurable duration. The cloud infrastructure may support dynamic deployment, management, and scaling of services associated with the streaming service.

To streamline the producer and consumer organizations, the processing pipeline may activate a plurality of sub-services that may be designed to enable secure and efficient communication across independent systems. These sub-services may include: merging the first pull request from the producer organization and the second pull request from the consumer organization into a combined contract definition; automatically generating a Java client based on the merged contract; distributing the generated Java client to both organizations (e.g., the producer organization and the consumer organization) via an artifactory; and utilizing the distributed Java client to facilitate bidirectional communication through the streaming service.

Enterprise healthcare platforms may often comprise of a multitude of independent systems, such as patient registration, billing, diagnostics, pharmacy, insurance processing, and electronic health records (EHRs), among others, that may encounter a number of technical problems during ross-system communication. One such problem may relate to interoperability, as these systems may typically operate using disparate protocols or custom-built application programmable interfaces (APIs), making seamless communication exchange difficult across independent systems. Additionally, existing independent systems may face a technical problem of data security: a concern due to sensitive and confidential nature of healthcare data streams that may require robust encryption and access control mechanisms. The existing independent systems may further comprise complex and fragmented connection architectures, which may lead to operational inefficiencies, including manual interventions, troubleshooting difficulties, increased fault rates, and limited scalability, thereby alleviating system reliability and performance.

The disclosed techniques may address the technical problem corresponding to the interoperability by introducing the streaming service that may operate as a unified platform deployed on the cloud infrastructure. This platform may provide a bidirectional messaging interface that may enable seamless communication between the producer organization and the consumer organization. To facilitate this communication, some of the disclosed techniques may incorporate a control plane, maybe implemented as a logical service or a set of services, responsible for managing interoperability workflows and aligning the consumer organization with the producer organization. The control plane may execute a series of operations to onboard the consumer organization, enabling exchange of data streams in a standardized format via the streaming service. These operations may include validating the consumer organization by cross-referencing metadata from the second pull request against the first pull request submitted by the producer organization. Further, the validated consumer organization may be authorized to access encrypted event messages originating from the producer organization, thereby promoting interoperability across independent systems.

Some of the disclosed techniques may alleviate the technical problem corresponding to the data security by incorporating multiple security layers to manage encryption and decryption operations associated with the cross-system communication. These layers may include mutual transport layer security (mTLS), which may enable bidirectional authentication and encrypted data transport between authorized organizations, and open authorization (OAuth), which may facilitate token-based access control. Moreover, some of the disclosed techniques may integrate fast healthcare interoperability resources (FHIR) consent and audit standards to monitor the data stream’s access and enforce organization-specific permissions. Collectively, the aforementioned security layers may establish a multi-layered security network that may support confidentiality, integrity, and traceability throughout the cross-system communication. Furthermore, some of the disclosed techniques may involve generation of cryptographic key pairs for both the producer and consumer organizations to secure data exchange. The key pairs may also be dynamically updated in response to specific conditions, such as key expiration, changes in configuration parameters, or revocation events. This dynamic key management may enable both organizations to securely encrypt and decrypt their respective data streams, thereby supporting robust security mechanisms for communication exchange.

Further, some of the disclosed techniques may address the technical problem of the complex and fragmented connection architectures across the independent systems by deploying a Java client to both the producer and consumer organizations. This Java client, generated as a software artifact, may be delivered as a lightweight executable package or a containerized service, enabling seamless integration into each organization's environment. The Java client may be automatically generated from a combined contract definition using a cloud-based build service (hereinafter referred to as a code generation engine). The combined contract definition may reflect a mutual agreement derived from the pull requests submitted by the producer and consumer organizations, enabling effective data exchange through the streaming service. By encapsulating and abstracting the underlying complexity of disparate APIs, protocols, and connection mechanisms, a deployed Java client may simplify cross-system communication, reduce operational overhead, and enhance scalability and reliability across independent systems.

Some of the disclosed techniques may offer several technical advantages that may enhance robustness and efficiency of cross-system communication. By leveraging a cloud-based streaming service and automated Java client deployment, the disclosed techniques may facilitate high availability and scalability, enabling seamless expansion and continuous operation across diverse organizational environments. Integrated multi-layered security mechanisms, including mTLS, OAuth, and dynamic cryptographic key management, may provide strong data protection and obfuscation, safeguarding sensitive information during communication exchange. The use of a combined contract definition to generate the Java client and deploy the generated Java client to both organizations may reduce operational complexity by eliminating the need for customized APIs integrations and manual configurations. Furthermore, implementation of the control plane may enable onboarding of new organizations, collectively enhancing interoperability, maintainability and scalability.

To onboard the consumer organization, the control plane may execute a series of operations configured to validate and authorize access based on metadata associated with the second pull request. This metadata may include attributes such as entity identifier, domain affiliation, and access intent, which the control plane may evaluate prior to granting permission to receive the data streams from the producer organization. Validation may include cross-referencing the metadata from the second pull request against configuration parameters and object definitions associated with the producer organization. Upon successful validation, the control plane may authorize the consumer organization in accordance with a set of predefined policies, which may include role-based access control, domain-level trust boundaries, and stream-specific encryption requirements. These policies may collectively govern how consumer organizations interact with the producer organizations and may ensure that the organizations with verified domain affiliations and legitimate access intents may be permitted to receive the encrypted event messages. This approach may facilitate secure, compliant, and context-aware communication exchange between the producer and consumer organizations. In some aspects, the onboarding process may be performed as an offline or one-time setup. Once the pull requests are merged into the combined contract definition, appropriate configurations and access policies may be established among both organizations, thereby eliminating the need of repetitive interactions.

In some aspects, some of the disclosed techniques may utilize a shepherd deployment process to facilitate controlled and reliable rollout of sub-services associated with the streaming service across producer and consumer organizations. The shepherd deployment process may refer to a coordinated deployment strategy that may provision services in a consistent, monitored, and staged manner. By leveraging this approach, some of the disclosed techniques may reduce downtime, mitigate deployment-related errors, and maintain operational continuity. Furthermore, the shepherd deployment across the producer and consumer organizations may enable consistent, reliable, and policy-compliant service rollout, supporting scalable and governed system behavior.

The streaming service may be deployed using the cloud infrastructure, which may provide required hosting resources to run and scale the service reliably. This infrastructure may be offered by a cloud provider, such as Google Cloud, Microsoft Azure, Amazon Web Services, Oracle Cloud, etc. To manage the flow of the data streams between the organizations, an object storage, offered by the cloud infrastructure may be used to store real-time or historical event messages, and cryptographic key pairs that may be generated based on the combined contract definition. These key pairs may be updated dynamically in response to conditions such as expiration, configuration changes, or revocation events occurred between the producer and consumer organizations, facilitating secure and effective communication exchange. Together, this infrastructure may support a flexible, secure, and scalable foundation for cross-organization data exchange.

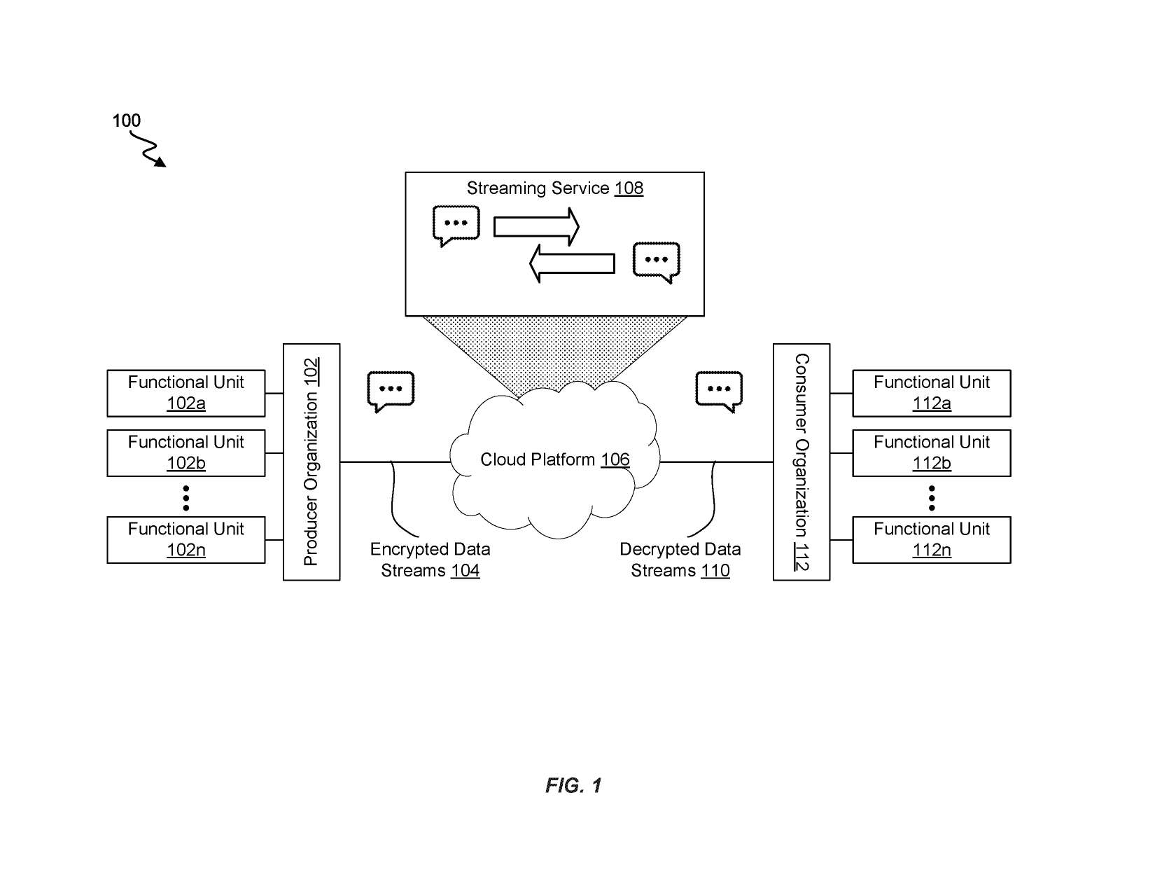

FIG. 1 illustrates an exemplary cross-communication architecture 100 configured to facilitate secure data exchange between a producer organization 102 and a consumer organization 112 via a streaming service 108, in accordance with some aspects of the present disclosure. The streaming service 108, operating as a centralized communication platform hosted on a cloud platform 106, may provide a bidirectional messaging interface between the producer organization 102 and the consumer organization 112. Through this bidirectional messaging interface, the producer organization 102 may deliver encrypted data streams 104 and the consumer organization 112 may receive decrypted data streams 110. The encrypted data streams 104 exchanged between organizations may include sensitive operational and transactional information that may require secure handling and controlled access. These streams may comprise of patient health records, diagnostic results, insurance claims, appointment schedules, and prescription details in healthcare; financial transactions, account statements, and compliance reports in banking; or shipment tracking, inventory updates, and vendor contracts in logistics. Upon successful validation and authorization, the consumer organization may receive the decrypted data streams 110 using cryptographic keys generated during onboarding, facilitating that permitted organizations can access and process the information.

The producer organization 102 may refer to an entity such as an organization, institution, or industry which may be composed of a plurality of functional units 102a, 102b, …, 102n. Each functional unit of the plurality of functional units 102a, 102b, …, 102n (hereinafter collectively referred to as functional units 102a–n or individually referred to as a functional unit 102) may represent a distinct service, department, or system within the producer organization 102 such as healthcare, education, or finance. These functional units 102a–n may generate event messages, telemetry data, or transactional records at predefined time intervals. Similarly, the consumer organization 112 may also correspond to an organization, institution, or industry comprising the functional units 112a–n, each representing an independent system or service designed to ingest, process, or respond to emitted data from the producer organization 102 in real-time or near-real-time.

The consumer organization 112 may refer to an entity such as an organization, institution, or industry which may be composed of a plurality of functional units 112a, 112b, …, 112n. Each functional unit of the plurality of functional units 112a, 112b, …, 112n (hereinafter collectively referred to as functional units 112a–n or individually referred to as a functional unit 112) may represent a distinct service, department, or system within the consumer organization 102 such as healthcare, education, or finance. In the context of an enterprise healthcare platform, the functional units 102a–n and 112a-n may represent various departments, services, or applications such as patient registration, billing, diagnostics, pharmacy, insurance processing, or electronic health records (EHR), each performing specialized roles.

These functional units may operate using their own customized application programmable interface (API) integrations or communication protocols, often relying on different technologies, data formats, platforms, or applications built on tailored firmware. Therefore, the communication protocols may lead to compatibility challenges when attempting secure and seamless communication among them. The data exchanged between these functional units may include patient demographics, lab results, prescriptions, appointment schedules, insurance claims, billing codes, or clinical notes. For instance, when a patient is admitted, a registration system may transmit patient details to EHR system, which in turn alerts diagnostics team to prepare relevant tests. Subsequently, lab results may be sent to the physician’s system, and billing information forwarded to the insurance processing system. This continuous flow of sensitive, structured data across diverse functional units may require a centralized platform through which multiple functional units may securely deliver, access, and process data streams in an efficient and coordinated manner.

The functional units 102a–n associated with the producer organization 102 and the functional units 112a–n associated with the consumer organization 112 may reside within an organization or enterprise, or may correspond to distinct organizations or enterprises, each requiring communication exchange. To enable seamless communication between these diverse and distributed functional units, the producer organization 102 and the consumer organization 112 may incorporate the streaming service 108, which may act as an intermediary architecture to standardize the data exchange process. The streaming service 108 may bridge a gap created by complex connections and protocols between the producer and consumer organizations by activating a processing pipeline. This pipeline may initiate a plurality of sub-services designed to support secure and efficient communication across independent systems (e.g., functional units). These sub-services may include merging a first pull request generated from the producer organization 102 and a second pull request generated from the consumer organization 112 into a combined contract definition. Based on the combined contract definition, a Java client may be automatically generated, which may further be distributed to both organizations (e.g., the producer organization 102 and the consumer organization 112) via an artifactory. The producer organization 102 and the consumer organization 112 may then utilize the distributed Java client to facilitate bidirectional communication through the deployed service (e.g., the streaming service 108). This deployment may enable business or organizational entities to exchange data streams in a reliable, scalable, and efficient manner, addressing communication complexities related to customized API integrations, unique connection mechanisms, and protocol-specific challenges associated with distinct producer and consumer organizations.

The streaming service 108 may be deployed using the cloud platform 106, which may provide an infrastructure required hosting resources to run and scale the service reliably. This infrastructure may be offered by a cloud provider, such as Google cloud, Microsoft Azure, Amazon web services, Oracle cloud, etc. The cloud platform 106 may be accessed via a network, enabling wireless interaction and communication with the streaming service 108. Network may include internet, an intranet, a wired LAN (local area network), a wireless LAN (WiLAN), a WAN (wide area network), a MAN (metropolitan area network), a PSTN (public switched telephone network) or any other type of communication network. Network may further include communication devices such as one or more gateways, routers, or bridges. In some aspects, the network may have one or more servers or websites accessible by independent systems to send and receive information. The network may be any type of network familiar to those skilled in the art that may support data communications using any of a variety of available protocols, including without limitation TCP/IP (transmission control protocol/Internet protocol), SNA (systems network architecture), IPX (internet packet exchange), AppleTalk®, etc.

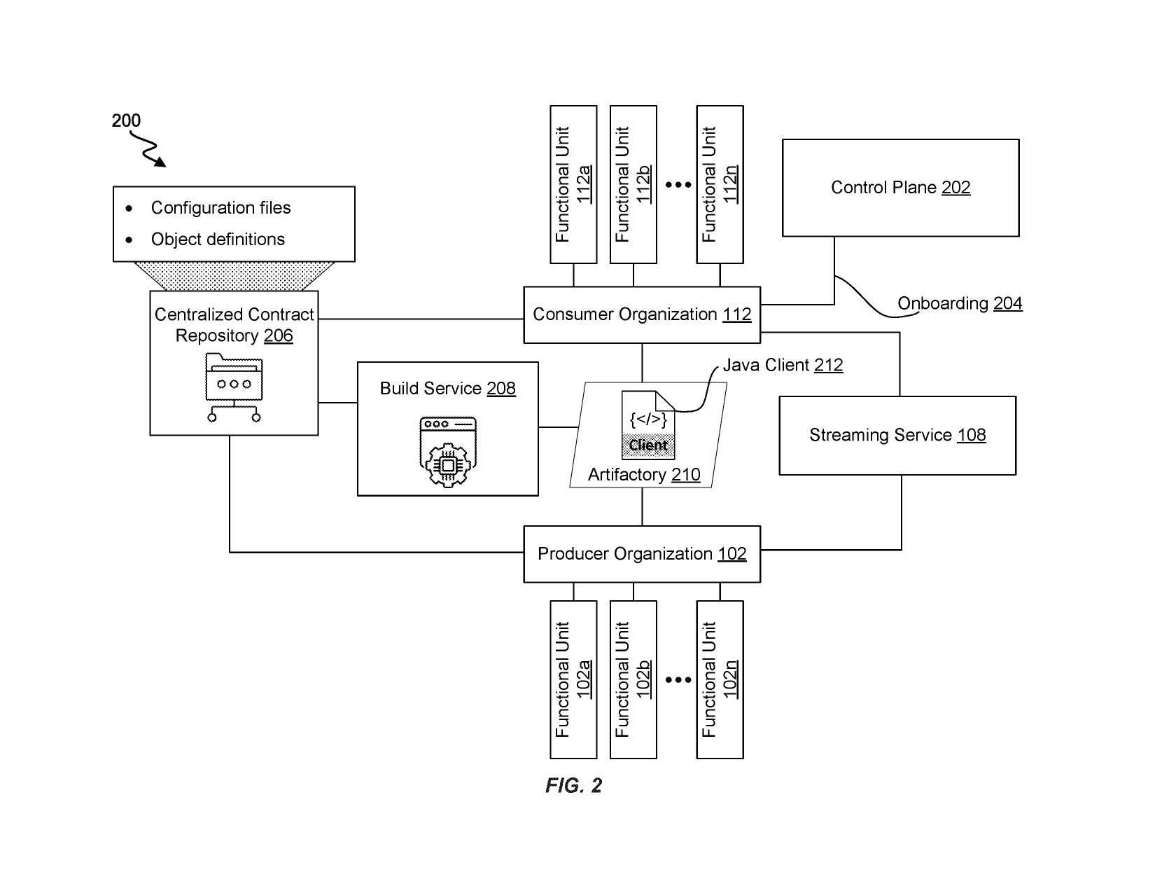

FIG. 2 illustrates a block diagram 200 depicting a streamlining of the producer organization 102 and the consumer organization 112 for secure data exchange via the streaming service 108, in accordance with some aspects of the present disclosure. To streamline communication between the producer organization 102 and the consumer organization 112, some of the disclosed techniques may activate the plurality of sub-services that may be designed to enable secure and efficient communication across independent systems. These sub-services may include: merging the first pull request from the producer organization 102 and the second pull request from the consumer organization 112 into a combined contract definition; automatically generating a Java client 212 based on the merged contract; distributing the generated Java client 212 to both organizations (e.g., the producer organization and the consumer organization) via an artifactory 210; and utilizing the distributed Java client 212 to facilitate bidirectional communication through the streaming service 108.

In some aspects, to merge the first pull request corresponding to the producer organization 102 and the second pull request corresponding to the consumer organization 112, a control plane 202 may be used to interpret both pull requests. These pull requests may refer to structured onboarding requests initiated by the producer organization 102 and the consumer organization 112 to define how they intend to participate in the data exchange process. The control plane 202 may be configured to execute the series of operations that validate and authorize the producer organization 102 and the consumer organization 112 for the delivery and access of encrypted data streams. Specifically, the control plane 202 may interpret the second pull request associated with the consumer organization 112 to facilitate its onboarding 204. To onboard the consumer organization 112 for accessing delivered data streams, the control plane 202 may perform validation and authorization operations based on the metadata associated with the second pull request. This metadata may comprise attributes such as entity identifier, domain affiliation, and access intent, which the control plane 202 may evaluate before granting permission to receive the data streams from the producer organization 102.

Validation may involve cross-referencing the metadata associated with the second pull request against the metadata associated with the producer organization 102. The metadata associated with the producer organization 102 may include entity identifier, configurational parameters, message types, object definitions, and unit tests. Upon successful validation, the control plane 202 may authorize the consumer organization 112 in accordance with the set of predefined policies, which may include role-based access control, domain-level trust boundaries, and stream-specific encryption requirements. These policies may collectively govern how consumer organizations interact with producer organizations and may ensure that the organizations with verified domain affiliations and legitimate access intents may be permitted to receive encrypted event messages (e.g., data streams). This approach may facilitate secure, compliant, and context-aware communication exchange between the producer and consumer organizations. In some aspects, the onboarding process may be performed as an offline or one-time setup. Once the corresponding pull requests are merged into the combined contract definition, appropriate configurations and access policies may be established among both organizations, thereby eliminating the need of repetitive interactions.

The Java client 212 may be automatically generated from the combined contract definition using a build service 208. The build service 208 may be a trained machine learning (ML) model, or a software-based utility that may be configured to generate the Java client 212 based on the combined contract definition. The combined contract definition may reflect a mutual agreement derived from respective pull requests received from the producer organization 102 and the consumer organization 112, enabling effective data exchange through the streaming service 208. The Java client 212 may be described as a deployable software artifact generated based on a combined contract definition associated with both the producer and consumer organizations. In one aspect, the Java client 212 may be generated using various programming technologies and may be adapted to align with the specific technological environment of the organization. This combined contract definition may be stored within a centralized contract repository 206, which may serve as a version-controlled source code repository or a bitbucket repository. The centralized contract repository 206 may also be dynamically updated to reflect changes in definitions, for example, entity identifiers, configuration files, or object definitions corresponding to the producer organization 102 and the consumer organization 112.

The generated Java client 212 may be distributed to both organizations using the artifactory 210—a repository manager designed to store, manage, and deliver software components such as build artifacts, libraries, and executables. This distribution process may enable each organization to receive correct and consistent version of the Java client 212. Once deployed, the Java client 212 may encapsulate and abstract the complexity of disparate APIs, protocols, and connection mechanisms, thereby simplifying cross-system communication, reducing operational overhead, and facilitating scalability and reliability across independent systems.

To address the compliance and security concerns, the Java client 212 may integrate multiple security layers to manage encryption and decryption operations associated with the cross-system communication. These layers may include mutual transport layer security (mTLS), and open authorization (OAuth), or fast healthcare interoperability resources (FHIR) consent and audit standards to monitor data stream access and enforce organization-specific permissions. Collectively, the security layers may establish a multi-layered security network that may support confidentiality, integrity, and traceability throughout the cross-system communication.

In some aspects, the Java client 212 may be deployed using a shepherd deployment process to facilitate controlled and reliable rollout of sub-services associated with the streaming service 208 across the producer organization 102 and the consumer organization 112. The shepherd deployment process may refer to a coordinated deployment strategy that may ensure services are provisioned in a consistent, monitored, and staged manner. By leveraging this approach, the disclosed techniques may reduce downtime, mitigate deployment-related errors, and maintain operational continuity. Furthermore, the shepherd deployment across producer and consumer organizations may enable consistent, reliable, and policy-compliant service rollout, supporting scalable and governed system behavior.

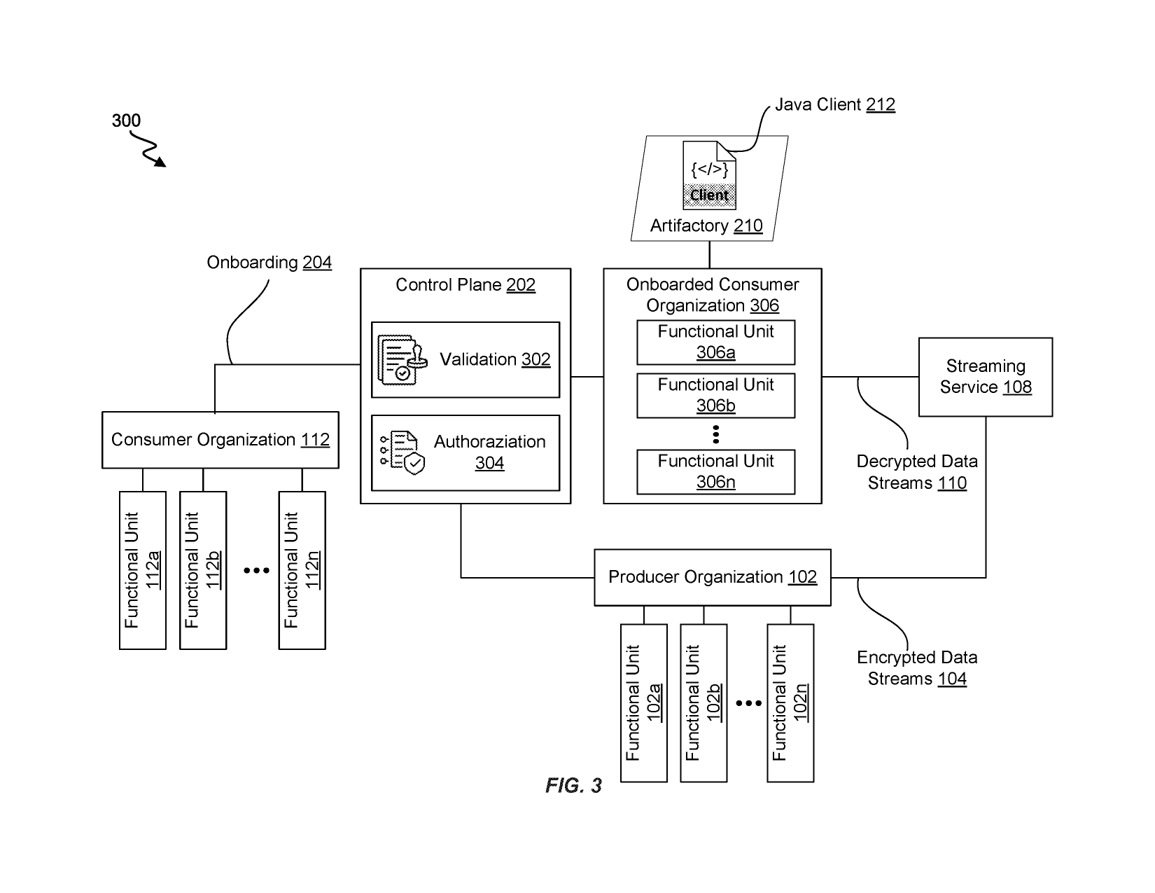

FIG. 3 illustrates a block diagram 300 depicting the onboarding 204 of the consumer organization 112 by leveraging the control plane 202, in accordance with at least one aspect of the present disclosure. The control plane 202 may be configured to execute the series of operations that validate and authorize both the producer organization 102 and the consumer organization 112 based on their respective pull requests for the delivery and access of the encrypted data streams 104. In some aspects, the control plane 202 may interpret the second pull request associated with the consumer organization 112 to initiate its onboarding 204. As part of this onboarding process, the control plane 202 may perform validation 302 and authorization 304 procedures based on the metadata encapsulated within the second pull request. This metadata may include attributes such as the entity identifier, the domain affiliation, and the access intent, which the control plane 202 may evaluate prior to granting the consumer organization 112 permission to receive the data streams from the producer organization 102.

The entity identifier may uniquely distinguish between each producer or consumer organization within the system, enabling the downstream processing of streamlining both the producer organization 102 and the consumer organization 112, or their traceability within the system. The domain affiliation may specify an operational or organizational scope—such as a clinical department, business unit, or service boundary—to which the entity (e.g., the producer organization 102 or the consumer organization 112) may belong. The domain affiliation may enable the control plane 202 to authorize associated entities that may closely align in their domains or scopes by applying domain-specific enforcement policies. Furthermore, the access intent within the second pull request may define a purpose or nature of the interaction being requested (e.g., whether the organization seeks to publish, subscribe, or both), guiding authorization and stream provisioning decisions accordingly.

The validation 302 may involve cross-referencing the metadata associated with the second pull request against the metadata associated with the producer organization 102. The metadata associated with the producer organization 102 may include entity identifier, configurational parameters, message types, object definitions, and unit tests. Upon successful validation 302, the control plane 202 may perform authorization 304 of the consumer organization 112 in accordance with the set of predefined policies, which may include role-based access control, domain-level trust boundaries, and stream-specific encryption requirements. These policies may collectively govern how the consumer organizations interact with the producer organizations and may ensure that the organizations with verified domain affiliations and legitimate access intents may be permitted to receive encrypted event messages (e.g., data streams). This approach facilitates secure, compliant, and context-aware communication exchange between producer and consumer organizations. In some aspects, the onboarding process may be performed as an offline or one-time setup. Once the corresponding pull requests are merged into the combined contract definition, appropriate configurations and access policies may be established among both organizations, thereby eliminating the need of repetitive interactions.

Once the consumer organization is onboarded within the system, the Java client 212 may be distributed to the onboarded consumer organization 306 via the artifactory 210, enabling the onboarded consumer organization 306 to receive the decrypted data streams 110 via the streaming service 108. The Java client 212 may be configured using the combined contract definition stored within the centralized contract repository 206, enabling seamless integration of streamlining operations, or multiple security layers to support secure and effective communication exchange. To facilitate secure communication exchange, the Java client 212 may generate cryptographic key pairs for both the producer organization 102 and the consumer organization 112 to secure data exchange. These key pairs may be dynamically updated in response to specific conditions, such as key expiration, changes in configuration parameters, or revocation events. This dynamic key management may enable both organizations to securely encrypt and decrypt their respective data streams, thereby supporting robust security mechanisms for communication exchange.

The onboarded consumer organization 306 may comprise a plurality of functional units 306-a, 306-b, …, 306-n, each representing an independent service, an application, or a platform within the onboarded consumer organization 306. Each functional unit may be configured to receive the decrypted data streams 110 via the streaming service 108. In some aspects, to receive the decrypted data streams 110, each functional unit 306a, 306b,…, 306n of the onboarded consumer organization 306 may be configured to subscribe to the associated producer organization 102 that may publish the encrypted data streams 104 via the streaming service 108.

In some aspects, the communication exchanged between the producer organization 102 and the consumer organization 112 may comprise structured healthcare data, which may be formatted using HL7 Millennium standards. HL7 (health level seven) is an internationally recognized architecture/network for exchanging clinical and administrative information. The data exchanged may include patient demographics, lab results, prescriptions, appointment schedules, billing codes, and clinical notes, which may be structured according to HL7 message formats. By leveraging the HL7 Millennium, the streaming service 108 may enable the disparate systems within or across organizations to interpret and process healthcare data consistently, thereby enhancing interoperability, reducing integration complexity, and supporting secure and compliant communication across independent systems.

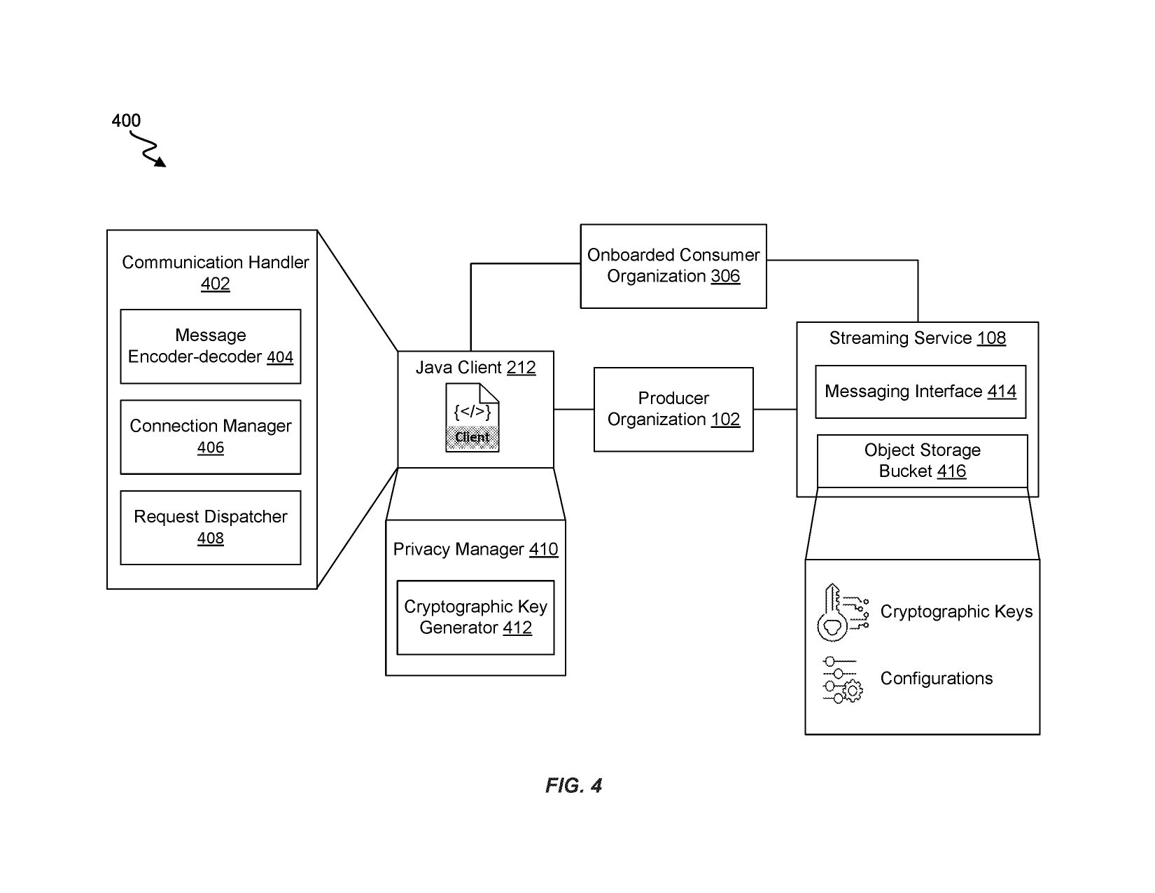

FIG. 4 is an exemplary block diagram 400 illustrating deployment of the Java client 212 to facilitate secure communication exchange via the streaming service 108, in accordance with some aspects of the present disclosure. The Java client 212 may be a deployable software artifact generated based on a combined contract definition associated with both the producer organization 102 and the onboarded consumer organization 306. The Java client 212 may include a communication handler 402, and a privacy manager 410 to support secure and reliable data exchange. Once deployed, the Java client 212 may encapsulate and abstract the complexity of disparate APIs, protocols, and connection mechanisms, thereby simplifying cross-system communication, reducing operational overhead, and facilitating scalability and reliability across independent systems.

The communication handler 402 may be configured to manage bidirectional messaging between the producer organization 102 and the onboarded consumer organization 306, abstracting protocol-specific complexities and enabling consistent data flow. The communication handler 402 within the Java client 212 may serve as a core module responsible for managing secure and reliable data transmission between the producer organization 102 and the onboarded consumer organization 306. The communication handler 402 may include transport layer integration to support protocols such as HTTP, HTTPS, WebSocket, etc., enabling flexible connectivity across diverse environments. The communication handler 402 may include a message encoder-decoder 404 that may handle serialization and deserialization of structured data formats such as JSON, XML, or HL7, facilitating standardization across the system.

In some aspects, the communication handler 402 may maintain persistent or transient connections, implement retry and timeout logic, and handle reconnections as needed, by leveraging a connection manager 406. In some aspects, the connection manager 406 may facilitate error handling mechanisms to capture failures and trigger fallback procedures. Additionally, a request dispatcher 408 may route incoming and outgoing messages to appropriate service endpoints. Collectively, these components may enable the Java client 212 to abstract protocol-specific complexities and facilitate seamless, secure, and scalable communication across independent systems. Abstraction may refer to the encapsulation of complex communication logic, security protocols, and data handling mechanisms into simplified, reusable artifacts of the Java client 212. In some aspects, the abstraction may enable the producer organization 102 and the consumer organization 112 to interact with the streaming service 108 by alleviating a need to manage low-level details like encryption, transport protocols, or access validation manually.

To manage encryption and decryption operations associated with the cross-system communication, a privacy manager 410 may integrate multiple security layers. These security layers may include mutual transport layer security (mTLS), which may enable bidirectional authentication and encrypted data transport between authorized organizations, and open authorization (OAuth), which may facilitate token-based access control. In some aspects, the privacy manager 410 may integrate FHIR consent and audit standards to monitor data stream access and enforce organization-specific permissions. Collectively, these security layers may establish a multi-layered security network that may support confidentiality, integrity, and traceability throughout the cross-system communication. In some aspects, the privacy manager 410 may leverage a cryptographic key generator 412 to generate cryptographic key pairs for both the producer and consumer organizations to secure data exchange. These key pairs may be the public and private key pairs associated with the producer organization and the consumer organization may be dynamically updated in response to specific conditions, such as key expiration, changes in configuration parameters, or revocation events. This dynamic key management may enable both organizations to securely encrypt and decrypt their respective data streams, thereby supporting robust security mechanisms for communication exchange.

The deployment of the Java client 212 may facilitate the management of data streams between organizations by incorporating secure communication handling mechanisms. During the exchange of data between organizations, an object storage bucket 416 may be utilized by the streaming service 108 to store real-time or historical event messages, organizational configurations, and cryptographic key pairs generated based on the combined contract definition. The object storage bucket 416 may represent a dynamic storage solution that may support the storage and updating of event logs, configuration data, and cryptographic key pairs associated with participating organizations via the streaming service 108. The streaming service 108 may function as a unified platform, providing a messaging interface 414 that may enable the producer organization 102 and the onboarded consumer organization 306 to exchange encrypted data streams over a configurable duration, facilitating secure, scalable, and policy-compliant communication.

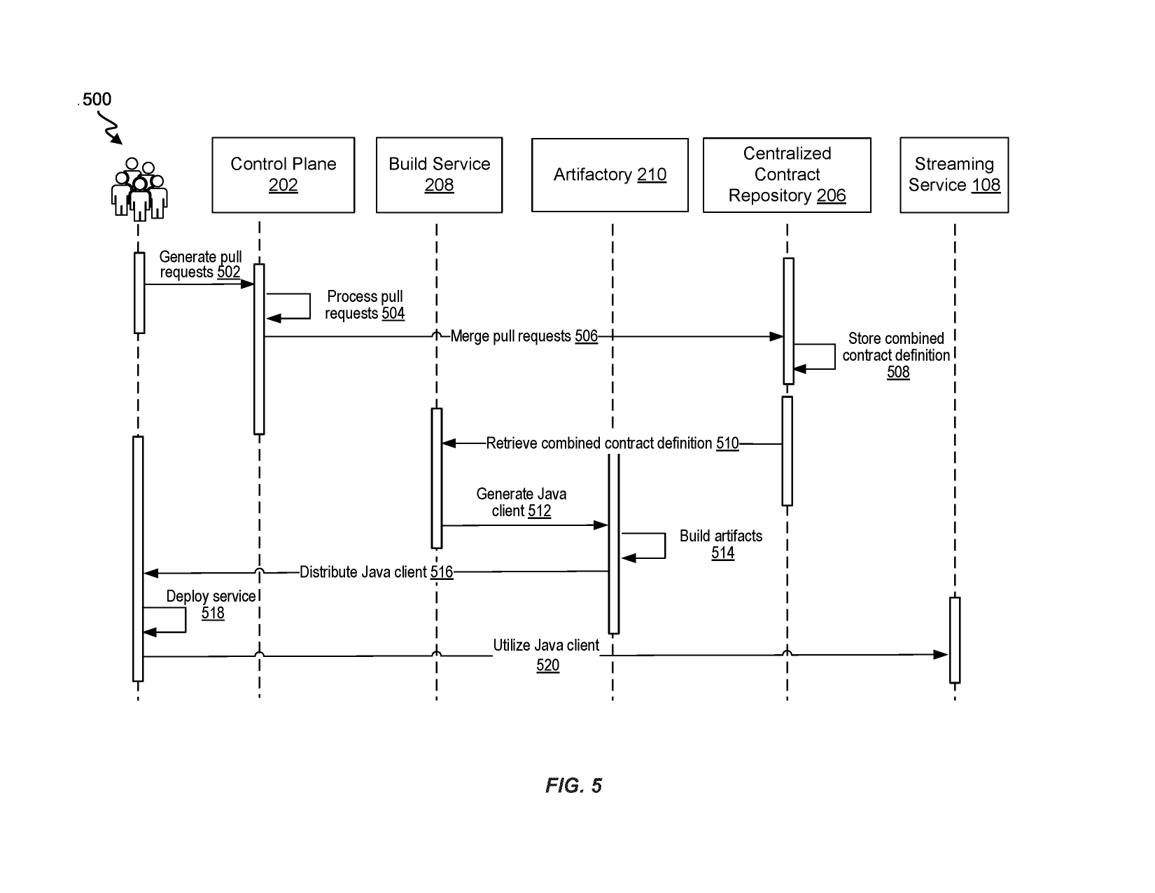

FIG. 5 illustrates a sequence diagram 500 of secure data exchange between the producer organization 102 and the consumer organization 112 via the streaming service 108, in accordance with some aspects of the present disclosure. The processes in the sequence diagram 500 are illustrated in a specific order, while the order can be modified, for example, some processes may be performed before others, and some processes may be performed simultaneously. The processes may be performed by hardware, software, or a combination thereof.

At 502, the control plane 202 may receive pull requests from the organizations such as the producer organization 102 and the consumer organization 112. The pull requests may comprise the first pull request comprising definitions specific to and generated by the producer organization 102 and the second pull request comprising definitions specific to and generated by the consumer organization 112. At 504, the control plane 202 may process the pull requests to streamline both the producer and the consumer organization. At 506, the control plane 202 may merge the received pull requests including the first pull request and the second pull request into the combined contract definition. The combined contract definition may refer to a unified set of rules that may reflect a mutual agreement derived from the received pull requests generated by the producer and consumer organizations, enabling effective data exchange through the streaming service 108. At 508, the centralized contract repository 206 that may serve as a version-controlled source code repository may be utilized to store the combined contract definition. The centralized contract repository 206 may also be dynamically updated to reflect changes in definitions corresponding to the producer organization 102 and the consumer organization 112.

At 510, the build service 208 may retrieve the combined contract definition from the centralized repository 206 to generate the Java client 212. At 512, the build service 208 may automatically generate the Java client 212 based on the retrieved combined contract definition. The build service 208 may be a trained machine learning (ML) model, or a software-based utility that may be configured to generate the Java client 212 based on the combined contract definition.

At 514, the artifactory 210—a repository manager designed to store, manage, and deliver software components such as build artifacts, libraries, and executables, may build artifacts of the generated Java client 212 to distribute them to corresponding organizations. At 516, the built artifacts of the generated Java client 212 may be distributed to both organizations using the artifactory 210. This distribution process may enable each organization to receive correct and consistent version of the Java client 212. Once deployed, the Java client 212 may encapsulate and abstract the complexity of disparate APIs, protocols, and connection mechanisms, thereby simplifying cross-system communication, reducing operational overhead, and facilitating scalability and reliability across independent systems. Abstraction may refer to the encapsulation of complex communication logic, security protocols, and data handling mechanisms into simplified, reusable artifacts of the Java client 212. In some aspects, the abstraction may enable the producer organization 102 and the consumer organization 112 to interact with the streaming service 108 by alleviating a need to manage low-level details like encryption, transport protocols, or access validation manually.

At 518, the producer and consumer organizations may leverage a shepherd deployment process to deploy the Java client 212. The shepherd deployment process may refer to a coordinated deployment strategy that may ensure services are provisioned in a consistent, monitored, and staged manner. By leveraging this approach, the streaming service 108 may reduce downtime, mitigate deployment-related errors, and maintain operational continuity. The streaming service 108 may be deployed using cloud infrastructure, which may provide required hosting resources to run and scale the service reliably. This infrastructure may be offered by a cloud provider, such as Google cloud, Microsoft Azure, Amazon web services, Oracle cloud, etc.

At 520, the producer organization 102 and the consumer organization 112 may utilize the Java client to enable secure communication between both organizations. In some aspects, the Java client 212 may manage encryption and decryption operations associated with the cross-system communication. To manage encryption and decryption operations, it may be configured to generate cryptographic key pairs for both the producer and consumer organizations to secure data exchange. These generated key pairs may be dynamically updated in response to specific conditions, such as key expiration, changes in configuration parameters, or revocation events. This dynamic key management may enable both organizations to securely encrypt and decrypt their respective data streams, thereby supporting robust security mechanisms for communication exchange.

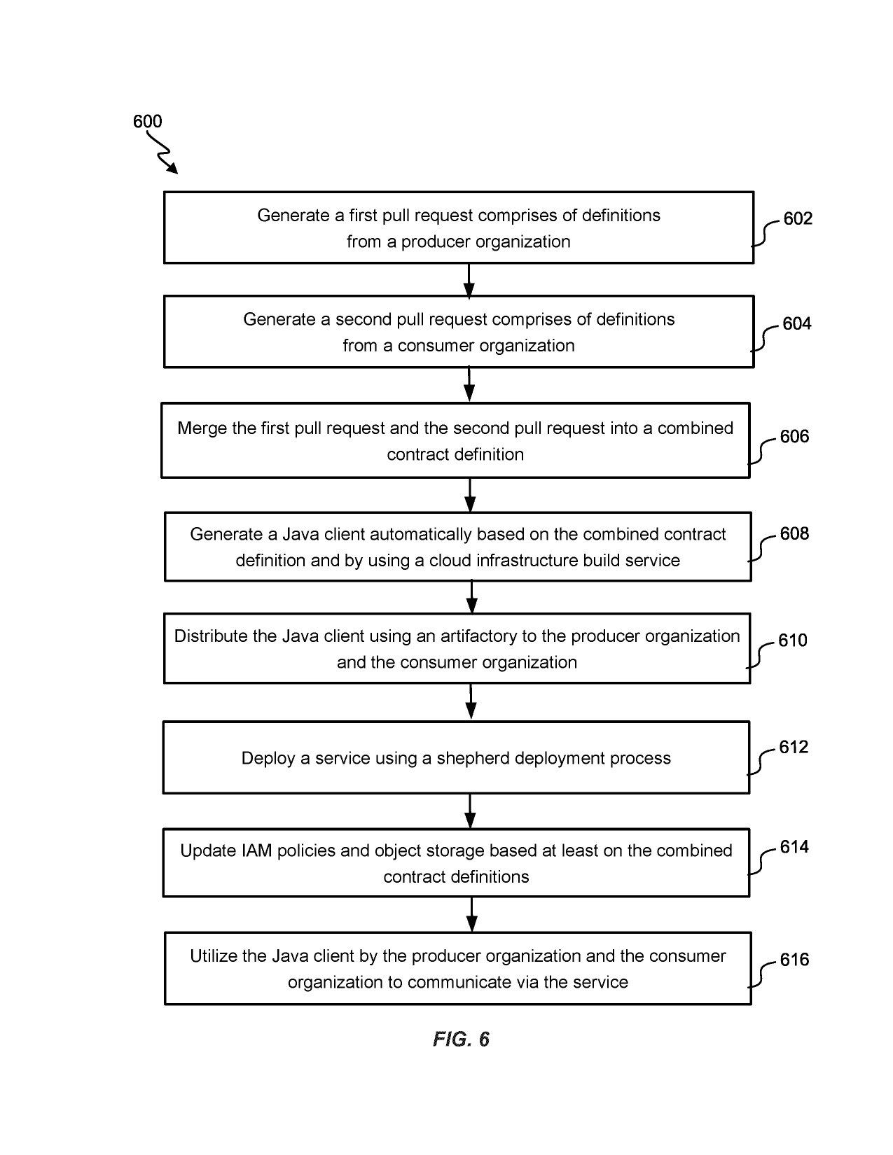

FIG. 6 illustrates a workflow 600 for enabling secure communication between the producer organization 102 and the consumer organization 112, in accordance with some aspects of the present disclosure. The blocks in workflow 600 are illustrated in a specific order, while the order can be modified, for example, some blocks may be performed before others, and some blocks may be performed simultaneously. The blocks may be performed by hardware, software, or a combination thereof. The workflow 600 may provide a mechanism for secure communication exchange between the producer organization 102 and the consumer organization 112.

At block 602, a first pull request comprising definitions specific to the producer organization 102 may be generated by the producer organization 102. At block 604, a second pull request may be generated, which may comprise definitions specific to the consumer organization 112. These definitions may reflect metadata that may comprise configuration files, access intent, domain affiliation, entity identifiers, and/or expected data formats of associated organizations.

At block 606, the generated pull requests (e.g., the first pull request and the second pull request) may be merged into the combined contract definition. The combined contract definition may refer to a unified set of rules that may reflect a mutual agreement derived from the pull requests generated by the producer and consumer organizations, enabling effective data exchange through the streaming service 108.

At block 608, the combined contract definition may be used to automatically generate the Java client 212 by leveraging the build service 208 (e.g., the code generation engine). The build service 208 may automatically generate the Java client 212 based on the retrieved combined contract definition. The code generation engine may be a trained machine learning (ML) model, or a software-based utility that is configured to generate the Java client 212 based on the combined contract definition.

At block 610, the generated Java client 212 may be distributed to both the producer organization 102 and the consumer organization 112 using an artifactory 210. The artifactory 210 may be a repository manager designed to store, manage, and deliver software components such as build artifacts, libraries, and executables, may build artifacts of the generated Java client 212 to distribute them to corresponding organizations.

At block 612, the distributed Java client 212 may be deployed to each producer and consumer organization by leveraging a shepherd deployment process. The shepherd deployment process may refer to a coordinated deployment strategy that may ensure services are provisioned in a consistent, monitored, and staged manner. By leveraging this approach, the disclosed techniques may reduce downtime, mitigate deployment-related errors, and maintain operational continuity.

At block 614, the identity and access management (IAM) policies (e.g., multiple security layers) and the object storage bucket 416 may be updated based on the combined contract definition. The object storage bucket 416 may be utilized to store real-time or historical event messages, organizational configurations, and cryptographic key pairs generated based on the combined contract definition. The object storage bucket 416 may represent a dynamic storage solution that supports the storage and updating of event logs, configuration data, and cryptographic key pairs associated with participating organizations via the streaming service 108.

At block 616, the producer organization 102 and the consumer organization 112 may utilize the deployed Java client 212 to exchange their communication securely via the streaming service 108. The streaming service 108 may function as a unified platform, providing the messaging interface 414 that may enable the producer organization 102 and the onboarded consumer organization 306 to exchange encrypted data streams over a configurable duration, facilitating secure, scalable, and policy-compliant communication.

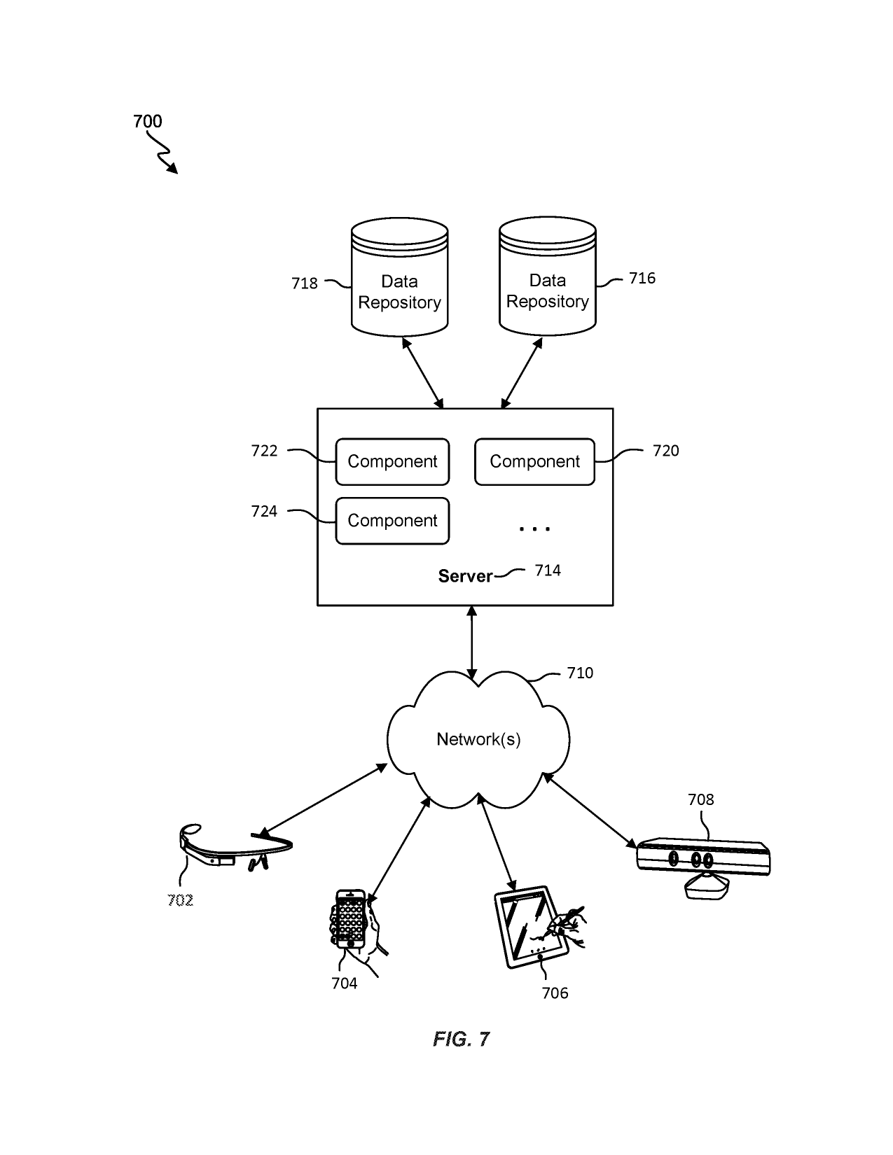

FIG. 7 depicts a simplified diagram of a distributed system 700 for implementing an aspect. In the illustrated aspect, distributed system 700 includes one or more client computing devices 702, 704, 706, 708, coupled to a server 714 via one or more communication networks. The client computing devices 702, 704, 706, 708, may be configured to execute one or more applications. In various aspects, server 714 may be adapted to run one or more services or software applications that enable techniques for the secure communication network. In certain aspects, server 714 may also provide other services or software applications that can include non-virtual and virtual environments. In some aspects, these services may be offered as web-based or cloud services, such as under a Software as a Service (SaaS) model to the users of client computing devices 702, 704, 706, 708. Users operating the client computing devices 702, 704, 706, 708, may in turn utilize one or more client applications to interact with server 714 to utilize the services provided by these components.

In the configuration depicted in FIG. 7, server 714 may include one or more components 720, 722 and 724 that implement the functions performed by server 714. These components may include software components that may be executed by one or more processors, hardware components, or combinations thereof. It should be appreciated that various system configurations are possible, which may be different from distributed system 700. The embodiment shown in FIG. 7 is thus one example of a distributed system for implementing an embodiment system and is not intended to be limiting.

Users may use the client computing devices 702, 704, 706, 708, for techniques in accordance with the teachings of this disclosure. A client device may provide an interface that enables a user of the client device to interact with the client device. The client device may also output information to the user via this interface. Although FIG. 7 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs.

Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various applications such as various Internet-related apps, communication applications (e.g., e-mail applications, short message service (SMS) applications) and may use various communication protocols.

Network(s) 710 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 710 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 714 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 714 can include one or more virtual machines running virtual operating systems, or other computing architectures involving virtualization such as one or more flexible pools of logical storage devices that can be virtualized to maintain virtual storage devices for the server. In various aspects, server 714 may be adapted to run one or more services or software applications that provide the functionality described in the foregoing disclosure.

The computing systems in server 714 may run one or more operating systems including any of those discussed above, as well as any commercially available server operating system. Server 714 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 714 may include one or more applications to analyze and consolidate data feeds and/or event updates received from users of client computing devices 702, 704, 706, 708. As an example, data feeds and/or event updates may include blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 714 may also include one or more applications to display the data feeds and/or real-time events via one or more display devices of client computing devices 702, 704, 706, 708.

The distributed system 700 may also include one or more data repositories 716, 718. These data repositories may be used to store data and other information in certain aspects. For example, one or more of the data repositories 716, 718 may be used to store information for techniques disclosed herein. Data repositories 716 and 718 may reside in a variety of locations. For example, a data repository used by server 714 may be local to server 714 or may be remote from server 714 and in communication with server 714 via a network-based or dedicated connection. Data repositories 716 and 718 may be of several types. In certain aspects, a data repository used by server 714 may be a database, for example, a relational database, a container database, an Exadata® storage device, or other data storage and retrieval tools such as databases provided by Oracle Corporation® and other vendors. One or more of these databases may be adapted to enable storage, update, and retrieval of data to and from the database in response to structured query language (SQL)-formatted commands.

In certain aspects, one or more data repositories 716, 718 may also be used by applications to store application data. The data repositories used by applications may be of several types such as, for example, a key-value store repository, an object store repository, or a general storage repository supported by a file system.

In one embodiment, server 714 is part of a cloud-based system environment in which diverse services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices to perform the requested services and keep tenant data confidential from other tenants.

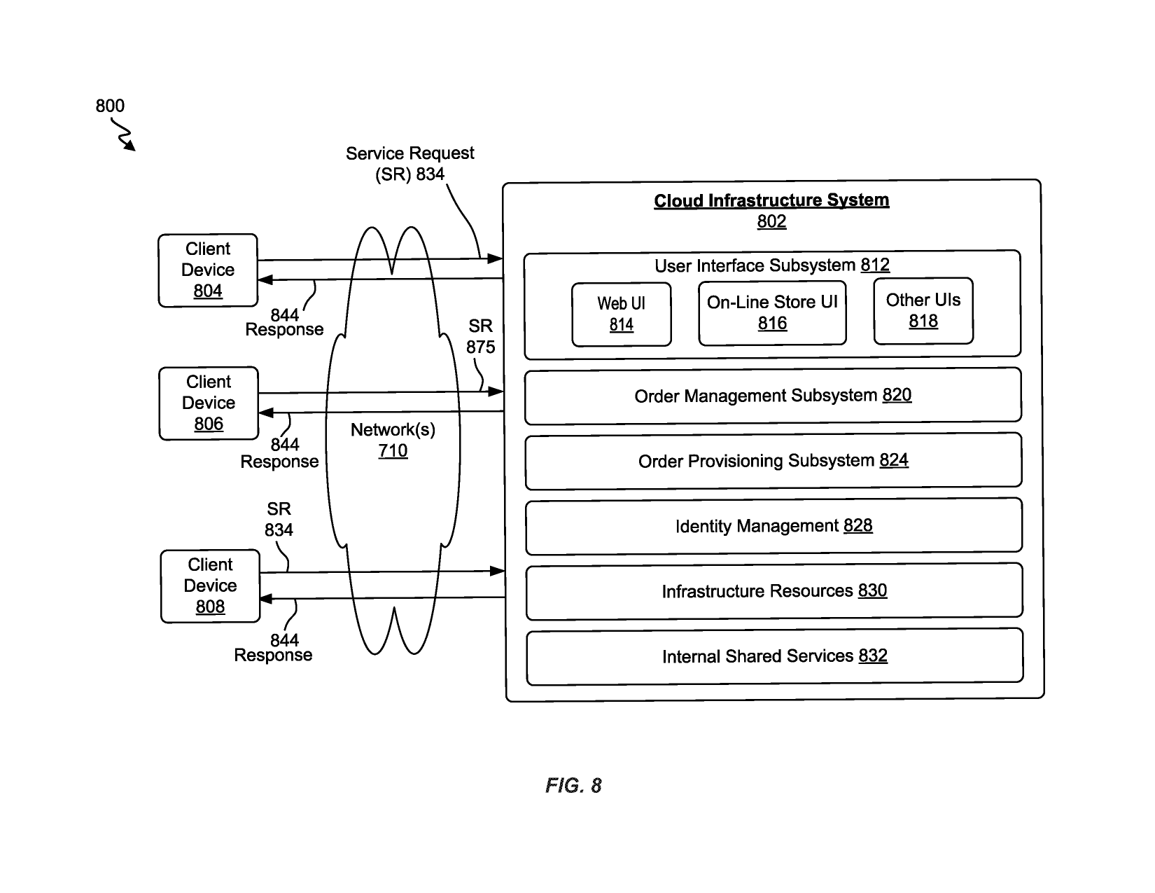

FIG. 8 is a simplified block diagram of a cloud-based system environment 800 in accordance with certain aspects of various embodiments of the disclosure. In the embodiment depicted in FIG. 8, cloud infrastructure system 802 may provide one or more cloud services hosted on the cloud platform 106 that may be requested by users using one or more client devices 804, 806, and 808. Cloud infrastructure system 802 may comprise one or more computers and/or servers that may include those described above for server 714. The computers in cloud infrastructure system 802 may be organized as general-purpose computers, specialized server computers, server farms, server clusters, or any other appropriate arrangement and/or combination.

Network(s) 710 may facilitate communication and exchange of data between the client devices 804, 806, and 808 and cloud infrastructure system 802. Network(s) 710 may include one or more networks. The networks may be of the same or several types. Network(s) 710 may support one or more communication protocols, including wired and/or wireless protocols, for facilitating the communications.

The embodiment depicted in FIG. 8 is only one example of a cloud infrastructure system and is not intended to be limiting. It should be appreciated that, in some other aspects, cloud infrastructure system 802 may have more or fewer components than those depicted in FIG. 8, may combine two or more components, or may have a different configuration or arrangement of components. For example, although FIG. 8 depicts three client devices, any number of client devices may be supported in alternative aspects.

The term cloud service is used to refer to a service that is made available to users on demand and via a communication network such as the Internet by systems (e.g., cloud infrastructure system 802) of a service provider. Typically, in a public cloud environment, servers and systems that make up the cloud service provider's system are different from the cloud customer’s (“tenant’s”) own on-premises servers and systems. The cloud service provider’s systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via the network(s) 710 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 802 may provide one or more cloud services using different models such as a Software as a Service (SaaS) model, a Platform as a Service (PaaS) model, an Infrastructure as a Service (IaaS) model, a Data as a Service (DaaS) model, and others, including hybrid service models. Cloud infrastructure system 802 may include a suite of databases, middleware, applications, and/or other resources that enable provision of the various cloud services.

A SaaS model enables an application or software to be delivered to a tenant’s client device over a communication network like the Internet, as a service, without the tenant having to buy the hardware or software for the underlying application. For example, a SaaS model may be used to provide tenants with access to on-demand applications that are hosted by cloud infrastructure system 802. Examples of SaaS services provided by Oracle Corporation® include, without limitation, diverse services for human resources/capital management, client relationship management (CRM), enterprise resource planning (ERP), supply chain management (SCM), enterprise performance management (EPM), analytics services, social applications, and others.

An IaaS model is used to provide infrastructure resources (e.g., servers, storage, hardware, and networking resources) to a tenant as a cloud service to provide elastic compute and storage capabilities. Various IaaS services are provided by Oracle Corporation®.

A PaaS model is used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is used to provide data as a service. Datasets may be searched, combined, summarized, and downloaded or placed into use between applications. For example, user profile data may be updated by one application and provided to another application. As another example, summaries of user profile information generated based on a dataset may be used to enrich another dataset.

Cloud services are provided on an on-demand self-service basis, subscription-based, elastically scalable, reliable, highly available, and secure manners. For example, a tenant, via a subscription order, may order one or more services provided by cloud infrastructure system 802. Cloud infrastructure system 802 then performs processing to provide the services requested in the tenant's subscription order. Cloud infrastructure system 802 may be configured to provide one or even multiple cloud services.

Cloud infrastructure system 802 may provide the cloud services via different deployment models. In a public cloud model, cloud infrastructure system 802 may be owned by a third-party cloud services provider and the cloud services are offered to any public tenant, where the tenant can be an individual or an enterprise. In certain other aspects, under a private cloud model, cloud infrastructure system 802 may be operated within an organization (e.g., within an enterprise organization) and services provided to clients that are within the organization. For example, the clients may be various departments or employees or other individuals of departments of an enterprise such as the Human Resources department, the payroll department, etc., or other individuals of the enterprise. In certain other aspects, under a community cloud model, the cloud infrastructure system 802 and the services provided may be shared by several organizations in a related community. Various other models such as hybrids of the above-mentioned models may also be used.

Client devices 804, 806, and 808 may be of several types (such as the client computing devices 702, 704, 706, and 708 depicted in FIG. 7) and may be capable of operating one or more client applications. A user may use a client device to interact with cloud infrastructure system 802, such as to request a service provided by cloud infrastructure system 802.

In some aspects, the processing performed by cloud infrastructure system 802 for providing chatbot services may involve big data analysis. This analysis may involve using, analyzing, and manipulating large data sets to detect and visualize various trends, behaviors, relationships, etc. within the data. This analysis may be performed by one or more processors, processing the data in parallel, performing simulations using the data, and the like. For example, big data analysis may be performed by cloud infrastructure system 802 for determining the intent of an utterance. The data used for this analysis may include structured data (e.g., data stored in a database or structured according to a structured model) and/or unstructured data (e.g., data blobs (binary large objects)).

As depicted in the embodiment in FIG. 8, cloud infrastructure system 802 may include infrastructure resources 830 that are utilized for facilitating the provision of various cloud services offered by cloud infrastructure system 802. Infrastructure resources 830 may include, for example, processing resources, storage or memory resources, networking resources, and the like.

In certain aspects, to facilitate efficient provisioning of these resources for supporting the various cloud services provided by cloud infrastructure system 802 for different tenants, the resources may be bundled into sets of resources or resource modules (also referred to as "pods"). Each resource module or pod may comprise a pre-integrated and optimized combination of resources of one or more types. In certain aspects, different pods may be pre-provisioned for several types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 802 may internally use services 832 that are shared by different components of cloud infrastructure system 802 and which facilitate the provisioning of services by cloud infrastructure system 802. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 802 may comprise multiple subsystems. These subsystems may be implemented in software, or hardware, or combinations thereof. As depicted in FIG. 8, the subsystems may include a user interface subsystem 812 that enables users of cloud infrastructure system 802 to interact with cloud infrastructure system 802. User interface subsystem 812 may include various interfaces such as a web UI 814, an online store UI 816 where cloud services provided by the cloud infrastructure system 802 are advertised and are purchasable by a consumer, and other UIs 818. For example, a tenant may, using a client device, request (service request 834) one or more services provided by cloud infrastructure system 802 using one or more interfaces 814, 816, and 818. For example, a tenant may access the online store, browse cloud services offered by cloud infrastructure system 802, and place a subscription order for one or more services offered by cloud infrastructure system 802 that the tenant wishes to subscribe to. The service request may include information identifying the tenant and one or more services that the tenant desires to subscribe to. For example, a tenant may place a subscription order for a chatbot related service offered by cloud infrastructure system 802. As part of the order, the client may provide information identifying the input (e.g., utterances).

In certain aspects, such as the embodiment depicted in FIG. 8, cloud infrastructure system 802 may comprise an order management subsystem (OMS) 820 that is configured to process the new order. As part of this processing, the OMS 820 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 820 may then invoke the order provisioning subsystem (OPS) 824 that is configured to provide resources for the order including processing, memory, and networking resources. The provisioning may include allocating resources for the order and configuring the resources to facilitate the service requested by the tenant order. The way resources are provisioned for an order and the type of the provisioned resources may depend upon the type of cloud service that has been ordered by the tenant. For example, according to one workflow, OPS 824 may be configured to determine the cloud service being requested and identify several pods that may have been pre-configured for that cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the requested tenant to provide the requested service.

Cloud infrastructure system 802 may send a response or notification 844 to the tenant to indicate when the requested service is now ready for use. In some instances, information (e.g., a link) may be sent to the tenant that enables the tenant to start using the benefits of the services requested.

Cloud infrastructure system 802 may provide services to multiple tenants. For each tenant, cloud infrastructure system 802 is responsible for managing information related to one or more subscription orders received from the tenant, maintaining tenant data related to the orders, and providing the requested services to the tenant or clients of the tenant. Cloud infrastructure system 802 may also collect usage statistics regarding a tenant's use of subscribed services. For example, statistics may be collected for storage used, the amount of data transferred, the number of users, and the amount of system up time and system down time, and the like. This usage information may be used to bill the tenant. Billing may be done, for example, on a monthly cycle.

Cloud infrastructure system 802 may provide services to multiple tenants in parallel. Cloud infrastructure system 802 may store information for these tenants, including proprietary information. In certain aspects, cloud infrastructure system 802 comprises an identity management subsystem (IMS) 828 that is configured to manage tenant’s information and provide the separation of the managed information such that information related to one tenant is not accessible by another tenant. IMS 828 may be configured to provide various security-related services such as identity services, such as information access management, authentication and authorization services, services for managing tenant identities and roles and related capabilities, and the like.

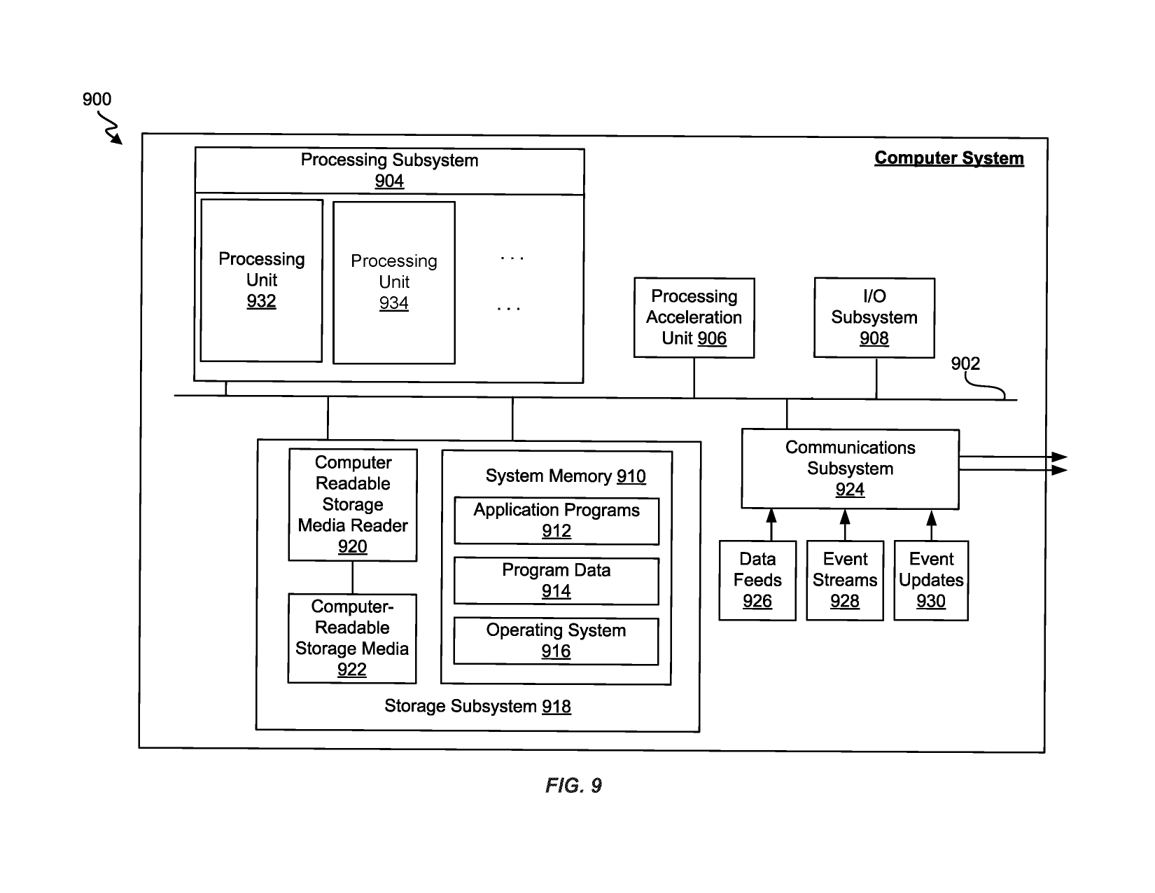

FIG. 9 illustrates a computer system 900 that may be used to implement certain aspects. As shown in FIG. 9, computer system 900 includes various subsystems including a processing subsystem 904 that communicates with several other subsystems via a bus subsystem 902. These other subsystems may include a processing acceleration unit 906, an I/O subsystem 908, a storage subsystem 918, and a communications subsystem 924. Storage subsystem 918 may include a computer-readable storage media reader 920, a computer-readable storage media 922, and a system memory 910.

Bus subsystem 902 provides a mechanism for letting the various components and subsystems of computer system 900 communicate with each other as intended. Although bus subsystem 902 is shown schematically as a single bus, alternative aspects of the bus subsystem may utilize multiple buses. Bus subsystem 902 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1396.1 standard, and the like.

Processing subsystem 904 controls the operation of computer system 900 and may comprise one or more processors, application specific integrated circuits (ASICs), or field programmable gate arrays (FPGAs). The processors may be single core or multicore processors. The processing resources of computer system 900 can be organized into one or more processing units 932, 934, etc. A processing unit may include one or more processors, one or more cores from the same or different processors, a combination of cores and processors, or other combinations of cores and processors. In some aspects, processing subsystem 904 can include one or more special purpose co-processors such as graphics processors, digital signal processors (DSPs), or the like. In some aspects, some or all the processing units of processing subsystem 904 can be implemented using customized circuits, such as application specific integrated circuits (ASICs), or field programmable gate arrays (FPGAs).

In some aspects, the processing units in processing subsystem 904 can execute instructions stored in system memory 910 or on computer-readable storage media 922. In various aspects, the processing units can execute a variety of programs or code instructions and can maintain multiple concurrently executing programs or processes. At any given time, some or all the program code to be executed can be resident in system memory 910 and/or on computer-readable storage media 922 including potentially on one or more storage devices. Through suitable programming, processing subsystem 904 can provide various functionalities described above. In instances where computer system 900 executes one or more virtual machines, one or more processing units may be allocated to each virtual machine.

In certain aspects, a processing acceleration unit 906 may optionally be provided for performing customized processing or for off-loading some of the processing performed by processing subsystem 904 to accelerate the overall processing performed by computer system 900.

I/O subsystem 908 may include devices and mechanisms for inputting information into computer system 900 and/or for outputting information from or via computer system 900. In general, use of the term input device is intended to include all types of devices and mechanisms for inputting information into computer system 900. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., "blinking" while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, the use of the term output device is intended to include all types of devices and mechanisms for outputting information from computer system 900 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 918 provides a repository or data store for storing information and data that is used by computer system 900. Storage subsystem 918 provides a tangible non-transitory computer-readable storage medium for storing the basic programming and data constructs that provide the functionality of some aspects. Storage subsystem 918 may store software (e.g., programs, code modules, instructions) that when executed by processing subsystem 904 provides the functionality described above. The software may be executed by one or more processing units of processing subsystem 904. Storage subsystem 918 may also provide a repository for storing data used in accordance with the teachings of this disclosure.

Storage subsystem 918 may include one or more non-transitory memory devices, including volatile and non-volatile memory devices. As shown in FIG. 9, storage subsystem 918 includes a system memory 910 and a computer-readable storage media 922. System memory 910 may include several memories including a volatile main random-access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 900, such as during start-up, may typically be stored in the ROM. The RAM typically contains data and/or programming modules that are presently being operated and executed by processing subsystem 904. In some implementations, system memory 910 may include multiple several types of memory, such as static random-access memory (SRAM), dynamic random-access memory (DRAM), and the like.

By way of example, and not limitation, as depicted in FIG. 9, system memory 910 may load application programs 912 that are being executed, which may include various applications such as Web browsers, mid-tier applications, relational database management systems (RDBMS), etc., program data 914, and an operating system 916. By way of example, operating system 916 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 922 may store programming and data constructs that provide the functionality of some aspects. Computer-readable storage media 922 may provide storage of computer-readable instructions, data structures, program modules, and other data for computer system 900. Software (programs, code modules, instructions) that, when executed by processing subsystem 904 provides the functionality described above, may be stored in storage subsystem 918. By way of example, computer-readable storage media 922 may include non-volatile memory such as a hard disk drive, a magnetic disk drive, an optical disk drive such as a CD ROM, digital video disc (DVD), a Blu-Ray® disk, or other optical media. Computer-readable storage media 922 may include Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magneto-resistive RAM (MRAM) SSDs, and hybrid SSDs that use a combination of DRAM and flash memory based SSDs.

In certain aspects, storage subsystem 918 may also include a computer-readable storage media reader 920 that can further be connected to computer-readable storage media 922. The computer-readable storage media reader 920 may receive and be configured to read data from a memory device such as a disk, a flash drive, etc.

In certain aspects, computer system 900 may support virtualization technologies, including virtualization of processing and memory resources. For example, computer system 900 may provide support for executing one or more virtual machines. In certain aspects, computer system 900 may execute a program such as a hypervisor that facilitates the configuration and management of the virtual machines. Each virtual machine may be allocated memory, computer (e.g., processors, cores), I/O, and networking resources. Each virtual machine runs independently of the other virtual machines. A virtual machine typically runs its own operating system, which may be the same as or different from the operating systems executed by other virtual machines executed by computer system 900. Accordingly, multiple operating systems may potentially be run concurrently by computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to establish a communication channel to one or more client devices via the Internet for receiving and sending information from and to the client devices. For example, the communications subsystem may be used to transmit a response to a user regarding the inquiry for a chatbot.

Communications subsystem 924 may support both wired and/or wireless communication protocols. For example, in certain aspects, communications subsystem 924 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 902.XX family standards, or other mobile communication technologies, or any combination thereof), global positioning system (GPS) receiver components, and/or other components. In some aspects, the communications subsystem 924 can provide wired network connectivity (e.g., Ethernet) in addition to or instead of a wireless interface.

Communications subsystem 924 can receive and transmit data in various forms. For example, in some aspects, in addition to other forms, communications subsystem 924 may receive input communications in the form of data feeds 926 that may be structured and/or unstructured, event streams 928, event updates 930, and the like. For example, communications subsystem 924 may be configured to receive (or send) data feeds 926 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 924 may be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to communicate data from computer system 900 to other computer systems or networks. The data may be communicated in various forms such as structured and/or unstructured data feeds, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 900 depicted in FIG. 9 is intended only as a specific example. Many other configurations having more or fewer components than the system depicted in FIG. 9 are possible. Based on the disclosure and teachings provided herein, a person of ordinary skill in art can appreciate other ways and/or methods to implement the various aspects.

Although specific aspects have been described, various modifications, alterations, alternative constructions, and equivalents are possible. Embodiments are not restricted to operation within certain specific data processing environments but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation, such as by executing computer instructions or code, or processors or cores programmed to execute code or instructions stored on a non-transitory memory medium, or any combination thereof. Processes can communicate using a variety of techniques including conventional techniques for inter-process communications, and different pairs of processes may use different techniques, or the same pair of processes may use different techniques at various times.

Specific details are given in this disclosure to provide a thorough understanding of the aspects. However, aspects may be practiced without these specific details. For example, well-known circuits, processes, algorithms, structures, and techniques have been shown without unnecessary detail to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specifications and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed:

1. A computer-implemented method comprising:
generating a first pull request comprising definitions from a producer organization;
generating a second pull request comprising definitions from a consumer organization;
merging the first pull request and the second pull request into a combined contract definition;
generating a Java client automatically based on the combined contract definition and by using a cloud infrastructure build service;
distributing the Java client using an artifactory to the producer organization and the consumer organization;
deploying a service using a shepherd deployment process;
updating identity and access management (IAM) policies and object storage based at least on the combined contract definition; and
utilizing the Java client by the producer organization and the consumer organization to communicate with each other via the service.

2. The computer-implemented method of claim 1, wherein the first pull request and the second pull request are submitted to a centralized contract repository.

3. The computer-implemented method of claim 2, wherein the centralized contract repository is implemented using a bitbucket repository.

4. The computer-implemented method of claim 1, wherein the first pull request is generated by a developer of the producer organization.

5. The computer-implemented method of claim 1, wherein the second pull request is generated by a developer of the consumer organization.

6. The computer-implemented method of claim 1, wherein the first pull request includes domain configuration files, object definitions, and unit tests.

7. The computer-implemented method of claim 1, wherein the object storage is used for storing configurations and public keys associated with organizations that use the service.

8. A system comprising:
one or more data processors; and
a non-transitory computer readable storage medium containing instructions which, when executed on the one or more data processors, cause the one or more data processors to perform a set of operations including:
generating a first pull request comprising definitions from a producer organization;
generating a second pull request comprising definitions from a consumer organization;
merging the first pull request and the second pull request into a combined contract definition;
generating a Java client automatically based on the combined contract definition and by using a cloud infrastructure build service;
distributing the Java client using an artifactory to the producer organization and the consumer organization;
deploying a service using a shepherd deployment process;
updating identity and access management (IAM) policies and object storage based at least on the combined contract definition; and
utilizing the Java client by the producer organization and the consumer organization to communicate with each other via the service.

9. The system of claim 8, wherein the first pull request and the second pull request are submitted to a centralized contract repository.

10. The system of claim 9, wherein the centralized contract repository is implemented using a bitbucket repository.

11. The system of claim 8, wherein the first pull request is generated by a developer of the producer organization.

12. The system of claim 8, wherein the second pull request is generated by a developer of the consumer organization.

13. The system of claim 8, wherein the first pull request includes domain configuration files, object definitions, and unit tests.

14. The system of claim 8, wherein the object storage is used for storing configurations and public keys associated with organizations that use the service.

15. A computer-program product tangibly embodied in a non-transitory machine-readable storage medium, including instructions configured to cause one or more data processors to perform a set of operations comprising:
generating a first pull request comprising definitions from a producer organization;
generating a second pull request comprising definitions from a consumer organization;
merging the first pull request and the second pull request into a combined contract definition;
generating a Java client automatically based on the combined contract definition and by using a cloud infrastructure build service;
distributing the Java client using an artifactory to the producer organization and the consumer organization;
deploying a service using a shepherd deployment process;
updating identity and access management (IAM) policies and object storage based at least on the combined contract definition; and
utilizing the Java client by the producer organization and the consumer organization to communicate with each other via the service.

16. The computer-program product of claim 15, wherein the first pull request and the second pull request are submitted to a centralized contract repository.

17. The computer-program product of claim 15, wherein the first pull request is generated by a developer of the producer organization.

18. The computer-program product of claim 15, wherein the second pull request is generated by a developer of the consumer organization.

19. The computer-program product of claim 15, wherein the first pull request includes domain configuration files, object definitions, and unit tests.

20. The computer-program product of claim 15, wherein the object storage is used for storing configurations and public keys associated with organizations that use the service.
